(19) United States
(12) Patent Application Publication
(10) Pub. No.: US 2024/0088737 A1
(43) Pub. Date: Mar. 14, 2024

(54) MAGENT WIRE WITH HIGH PARTIAL DISCHARGE INCEPTION VOLTAGE (PDIV)

(71) Applicant: REA Magnet Wire Company, Inc., Fort Wayne, IN (US)

(72) Inventors: Mark Seabury, Lansing, MI (US); Mark Edwin Stetler, Lafayette, IN (US); Michelle L. Whiteman, Lafayette, IN (US); Matthew Stowe, Fort Wayne, IN (US)

(21) Appl. No.: 18/275,072

(22) PCT Filed: Jan. 31, 2022
(86) PCT No.: PCT/US2022/014495

§ 371 Date: Jul. 31, 2023

Related U.S. Application Data
(60) Provisional application No. 63/144,013, filed on Feb. 1, 2021.

(51) Int. Cl. H02K 3/32; H01B 3/44; H02K 15/04

(52) U.S. Cl. CPC H02K 3/32; H01B 3/445; H02K 15/04

(57) ABSTRACT

An insulated wire includes insulation having organic filler particles distributed throughout a polymer matrix. The filler particles may be a fluoropolymer with a low relative permittivity and a high dielectric strength. This configuration achieves improved PDIV and dielectric characteristics for a given thickness of insulation, as compared to a comparable polymer insulation lacking the filler particles. The resulting wire may be used for high-voltage and severe-duty applications, preserving or improving performance while minimizing insulation thickness for additional spatial efficiency.

### CROSS REFERENCE TO RELATED APPLICATION

This application claims the benefit of U.S. Provisional Application Ser. No. 63/144,013, filed Feb. 1, 2021 and entitled MAGNET WIRE WITH HIGH PARTIAL DISCHARGE INCEPTION VOLTAGE (PDIV), the entire disclosure of which is hereby expressly incorporated herein by reference.

### TECHNICAL FIELD

The present disclosure relates to a coated electrical conductor and, in particular, to a magnet wire having at least one layer of insulation or enamel providing high partial discharge inception voltage (PDIV).

### BACKGROUND

Insulated electric conductors typically include one or more coated insulation layers, also referred to as wire enamel construction or coating compositions, formed around a conductive core. Magnet wire is one form of insulated electric conductor in which the conductive core is copper, aluminum, or copper clad aluminum, etc. and the insulation layer or layers comprise dielectric materials such as polymeric resins coated peripherally around the conductive core. The coating may be applied in multiple concentric layers until a desired enamel build or thickness has been achieved.

Magnet wire is used in a wide variety of electric machines and devices such as the electromagnetic windings of electric motors, generators, inverter drive motors and other electrical applications that require tight coils of insulated wire. The magnet wire insulation must be sufficiently durable and resistive to damage so that the insulative properties are maintained. In certain applications the magnet wire insulation must also retain its dielectric properties at high operating temperatures. For example, where an electric motor is controlled by a variable frequency drive or where the generator is connected to a transmission line, the magnet wire windings can see high operating voltages and temperatures where increased dielectric strength is desired and the magnet wire windings can see transient voltage spikes.

When insulation has a defect such as an internal void, the defect will display localized ionization when exposed to high voltage, with the threshold voltage also being a function of the insulation type and thickness. This ionization starts at one voltage, the “inception voltage” (IV) and stops at a lower voltage, the “extinction voltage” (EV). As high voltage is applied to the conductor and insulation, voltage also builds up across the defect or void. When the inception voltage is reached, the void ionizes, shorting itself out. When the voltage across the void drops below the extinction voltage, ionization ceases. This action redistributes charge within the barrier and is known as partial discharge (PD).

Measuring the bulk inception voltage for a given electrical component provides an absolute maximum rating for that component. This is called the partial discharge inception voltage (PDIV). Previous efforts have focused on producing magnet wire possessing high PDIV characteristics, typically with an insulation layer or layers made of thermoplastic resins that are applied to a suitable conductor using extrusion processes.

Corona discharge (CD) is an electrical discharge caused by the ionization of a fluid, such as air, surrounding a conductor carrying a high voltage. It represents a local region where the air (or other fluid) has undergone electrical breakdown and become conductive, allowing charge to continuously leak off the conductor into the fluid. Because CD may constitute a significant waste of electrical energy and may damage insulation and equipment, it is often sought to be minimized in high voltage applications.

What is needed is an improvement over the foregoing.

### SUMMARY

The present disclosure provides an insulated magnet wire in which the insulation includes organic filler particles distributed throughout a polymer matrix. The filler particles may be a fluoropolymer with a low relative permittivity and a high dielectric strength. This configuration achieves improved PDIV and dielectric characteristics for a given thickness of insulation, as compared to a comparable polymer insulation lacking the filler particles. The resulting wire may be used for high-voltage and severe-duty applications, preserving or improving performance while minimizing insulation thickness for additional spatial efficiency.

In one form thereof, the present disclosure provides a magnet wire, including a conductor wire and an insulation layer on the conductor wire. The insulation layer includes a polymer matrix and filler particles dispersed within the polymer matrix, the filler particles comprising a fluoropolymer and present in an amount of at least 20 wt. % based on a total weight of the insulation layer. The magnet wire has a partial discharge inception voltage of at least 1,200 volts as determined in accordance with CEI/IEC 60270:2000.

In another form thereof, the present disclosure provides a method of manufacturing magnet wire, including coating an insulation layer onto a conductor wire and curing, at least partially, the insulation layer. The insulation layer includes a liquid polymer matrix, fluoropolymer filler particles dispersed within the liquid polymer matrix, and the insulation layer including a total of less than 0.1 wt. % fluorinated surfactants, based on a total weight of the insulation layer.

In yet another form thereof, the present disclosure provides a magnet wire, including a conductor wire having a rectangular cross-section defining a width and a height less than the width, and an insulation layer on the conductor wire. The insulation layer includes a polymer matrix and filler particles dispersed within the polymer matrix, the filler particles comprising a fluoropolymer and present in an amount of at least 20 wt. % based on a total weight of the insulation layer.

While multiple embodiments are disclosed, still other embodiments will become apparent to those skilled in the art from the following detailed description, which shows and describes illustrative embodiments. Accordingly, the drawings and detailed description are illustrative in nature and not restrictive.

### BRIEF DESCRIPTION OF THE DRAWINGS

The above-mentioned and other features and advantages of this disclosure, and the manner of attaining them, will become more apparent and will be better understood by reference to the following description of exemplary embodiments taken in conjunction with the accompanying drawings, wherein:

FIG. 1A is a cross-section, elevation view of a wire according to embodiments of the present disclosure;

FIG. 1B is a cross-section, elevation view of a wire according to embodiments of the present disclosure;

FIG. 1C is a cross-section, elevation view of a rectangular wire according to embodiments of the present disclosure;

FIG. 2 is a perspective, schematic view of a production assembly for wire according to embodiments of the present disclosure;

FIG. 3 is a graph of test results for PDIV, drawn to scale, illustrating data indicative of control wires and wires made in accordance with the present disclosure;

FIG. 4 is a graph of test results for dielectric breakdown at room temperature, drawn to scale, illustrating data indicative of control wires and wires made in accordance with the present disclosure;

FIG. 5 is a graph of test results for dielectric breakdown at an elevated temperature, drawn to scale, illustrating data indicative of control wires and wires made in accordance with the present disclosure; and

FIG. 6 is a graph of test results for high voltage endurance, drawn to scale, illustrating data indicative of control wires and wires made in accordance with the present disclosure.

Corresponding reference characters indicate corresponding parts throughout the several views. The exemplification set out herein illustrates an exemplary embodiment of the invention and such exemplification is not to be construed as limiting the scope of the invention in any manner.

### DETAILED DESCRIPTION

The term “Partial Discharge Inception Voltage” or PDIV refers to the ability of an insulated wire to resist partial discharge at a given voltage. For purposes of the present disclosure, PDIV refers to PDIV peak voltage (rather than RMS voltage, for example). PDIV is further described in CEI/IEC 60270:2000, the entirety of which is incorporated by reference herein. For purposes of the present disclosure, PDIV may be estimated in magnet wire by the following equation (Dakin et al.):

V=√2×163×(t/εᵣ)^{0.46},
where V=PDIV (Vpeak);
εᵣ=relative permittivity of insulation; and
t=thickness of insulation (between a twisted pair of conductors).

“Permittivity” is a measure of the electric polarizability of a dielectric. A material with high permittivity polarizes more in response to an applied electric field than a material with low permittivity, thereby storing more energy in the material. Typical relative permittivity values of some known magnet wire insulation polymers are presented below in Table 1.

TABLE 1
Relative Permittivity of Magnet Wire Polymers

| Insulating material | Rel. Permittivity εᵣ |
|---|---|
| Polyamide-imide (PAI) | 3.9-7.3 |
| Polyester (PES) | 3.4-4.1 |
| Polyether ether ketone (PEEK) | 2.9-3.1 |
| Polyesterimide (PEI) | 3.1-3.2 |
| Polyphenylene Sulfide (PPS) | 3.2 |
| PEEK/PPS | 3.2 |
| Polyethylene terephthalate (PET) | 3.6 |
| Polyimide (PI) | 3.2 |

The relative permittivities and dielectric strengths of organic polymers that could potentially be used as enamel fillers for magnet wire are presented below in Table 2 as compared to air.

TABLE 2
Relative Permittivity & Dielectric Strength
of Selected Organic Polymers

| | Rel. | Dielectric |
|---|---|---|
| | Permittivity | Strength |
| Polymer | εᵣ | (kV/cm) |
| Air | 1.0 | 15-30 |
| Polypropylene (PP) | 2.2-2.36 | 200-280 |
| Polyethylene (PE) | 2.2-2.3 | 200-300 |
| Polystyrene (PS) | 2.4-2.7 | 150-200 |
| Poly (vinyl chloride) (PVC) | 2.9-3.1 | 100-300 |
| Polyphenylene sulfide (PPS) | 3.0-3.3 | 110-240 |
| Polyether ether ketone (PEEK) | 3.2 | 200 |
| Polytetrafluoroethylene (PTFE) | 2.1 | 480 |
| Perfluoroalkoxy (PFA) | 2.1 | 500 |
| Ethylene tetrafluoroethylene (ETFE) | 2.6 | 400 |
| Fluorinated ethylene propylene (FEP) | 2.1 | 500-600 |

“Dielectric breakdown” is a process that occurs when an electrical insulating material, subjected to a voltage exceeds the material's dielectric strength, becomes an electrical conductor and electric current flows through it. “Dielectric breakdown voltage” is the voltage at which an insulating material experiences dielectric breakdown. Dielectric breakdown is further described in ANSI/NEMA MW1000-2018 Section 3.8.3, the entirety of which is incorporated by referenced herein.

“High voltage endurance” evaluates magnet wire insulation under conditions of high voltage stress, where the voltage is sufficient to create visible corona. The corona is produced by the ionization of the medium surrounding the wire which, over time, can significantly degrade the insulation and result in dielectric failure. A version of high voltage endurance and testing of same is further described in ASTM D2275, the entirety of which is incorporated by referenced herein, except that high voltage endurance for wires made in accordance with the present disclosure are tested using a modified test protocol as described below.

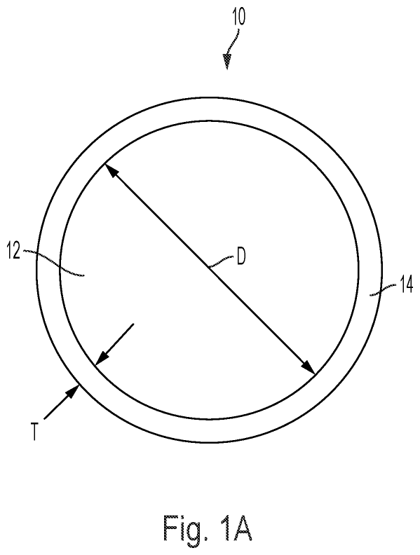

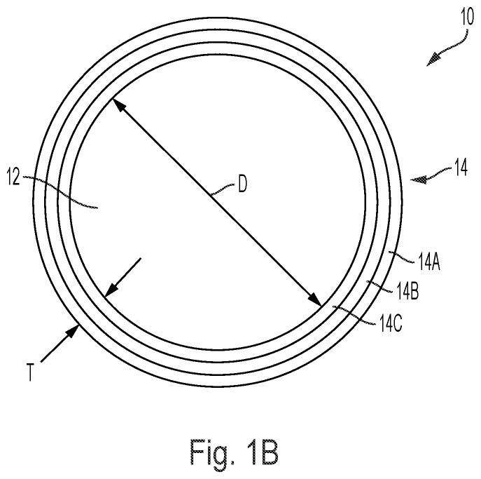

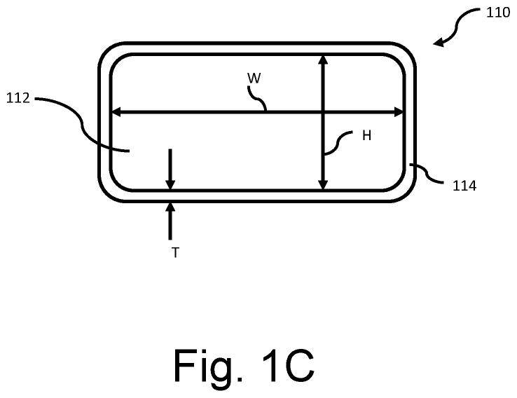

Referring now to FIG. 1A, wire 10 is shown including a conductive wire 12 and one or more layers of insulation 14 applied along the length of the wire 12. In the illustrated embodiment, conductor 12 defines diameter D and insulation 14 defines thickness T, which is substantially uniform around the circumference of conductor 12 along its length. As further described below, thickness T of insulation 14 may be minimized through its design and configuration, thereby allowing maximization of diameter D of conductor 12 for a given spatial constraint and within a given specification for PDIV and CD resistance.

In one exemplary embodiment, wire 10 may be a magnet wire is designed for use with electric motors of the type used in electric vehicles, such as traction motors. Such wires are subject to very high voltage spikes as the vehicle is driven by the operator, and must be therefore be engineered such that they have a high partial discharge inception voltage (PDIV) to avoid the wire encountering corona discharges during such voltage spikes. Wire 10 has a high PDIV but also preserves high electrical throughput and spatial efficiency, as described in detail below, such that wire 10 can withstand voltage spikes encountered in connection with electric vehicles while also minimizing overall size and cost.

Conductor 12 may be made of any suitable conductive material and in any suitable configuration, as required or desired for a particular application. Exemplary conductive materials include copper, including annealed copper, oxygen-free copper, fire-refined copper. Conductor 12 may also be made from, or include, other materials such as aluminum and copper clad aluminum. Exemplary configurations for conductor 12 include a single strand of conductive material having a cross-section shaped as circular, square, rectangular, ribbon, oval, or any other custom shape that may be desired.

Insulation 14 is a polymer-based insulation having filler particles, which interact to create an overall insulation construct that is highly resistant to partial discharge, has high dielectric strength, and has a high PDIV. Insulation 14 may include a bulk organic polymer matrix of the type set forth in Table 1 above, such as polyamide imide (PAI), polyester (PES) or polyimide (PI). As further described below, this bulk insulation polymer matrix is enhanced with filler particles made from organic perfluoropolymers, which possess both low relative permittivity and good dielectric strength. The fluoropolymer may be a perfluorinated fluoropolymer, including polytetrafluoroethylene (PTFE), fluorinated ethylene propylene (FEP), or perfluoroalkoxy (PFA). As used herein, the term “perfluoropolymer” or “perfluorinated fluoropolymer” refers to a fully fluorinated fluoropolymer, in which all of the hydrogens of the hydrocarbon backbones are substituted with fluorine atoms. This promotes thermal stability and high permittivity. In an exemplary embodiment, filler particles may have an average particle size from 0.1 μm, 5 μm or 10 μm to 30 μm, 50 μm or 100 μm or within any range using any two of the foregoing as endpoints.

In some embodiments of wire 10, such as the embodiment shown in FIG. 1A, insulation 14 may be formed as a single homogeneous layer which is in direct contact with conductor 12 at its inwardly-facing surface, and is exposed to the ambient environment at its outer surface.

Alternatively and with reference to FIG. 1B, insulation 14 may include multiple distinct layers, such as a basecoat 14A, a mid-coat 14B and a topcoat 14C. The basecoat 14A is in direct contact with the conductor 12 at its inwardly-facing surface and in contact with the mid-coat 14B at its outer surface, while the topcoat 14C is in direct contact with the mid-coat 14B at its inwardly-facing surface and exposed to the ambient environment at its outer surface. Similarly, additional mid-coats 14B may be applied as required or desired for a particular application, such that the multi-layer insulation 14 may have multiple layers.

The materials used for the various coats in multi-layer insulation 14 may be the same or different. In one exemplary embodiment, the basecoat layer 14A can be one of many polymers such as terephthalic acid alkyds (TAA), polyesters (PE), polyesterimides (PEI), polyamides (PA), polyamideimides (PAI), polyurethanes (PU), epoxy resins, polysulfones (PS), silicon resins and the like. The mid-coat layer 14B can be one of the above-mentioned polymers but incorporating an organic filler dispersed within the resin to provide the magnet wire with high PDIV characteristics as describe herein. The topcoat layer 14C can be chosen from among many polymers, including polyamideimides (PAI) or polyimides (PI).

For some wires 10 having multi-layer insulation 14, a mid-coat 14B may include a dispersion of organic filler as described above, while the other coats (e.g., the basecoat 14A and topcoat 14C) may lack the filler particles. In other embodiments, the organic filler may be dispersed in a plurality of the polymer layers so that two or more of the polymeric layers (base, mid and top) have enhanced PDIV characteristics.

As noted above, filler particles are added to the basic polymer matrix of insulation 14 to increase its PDIV for a given nominal thickness T. In particular, an organic filler including fluoropolymer particles is dispersed evenly throughout the polymer matrix, including at least 20 wt. % of the total weight of the insulation layer 14. In an exemplary embodiment, organic perfluoropolymer fillers particles are used. Organic perfluoropolymers have very low relative permittivity and possess excellent dielectric properties due the highly polarized nature of carbon-fluorine bonds, making them good candidates for enhancing the PDIV of insulation 14. In some embodiments, large amounts or “loadings” of filler particles may be used, from 20 wt. %, 22 wt. % or 24 wt. %, to 26 wt. %, 28 wt. %, or 30 wt. % based on the total weight of the insulation layer 14, or within any range using any two of the foregoing as endpoints. The inclusion of such particles reduces the relative permittivity of the insulation layer 14 and thereby elevates the PDIV of the wire 10. In addition to organic filler particles, insulation layer 14 may also include inorganic fillers such as alumina, titanium oxide or other mineral fillers which, if present, amount to no more than 5 wt. % of the total weight of insulation layer 14.

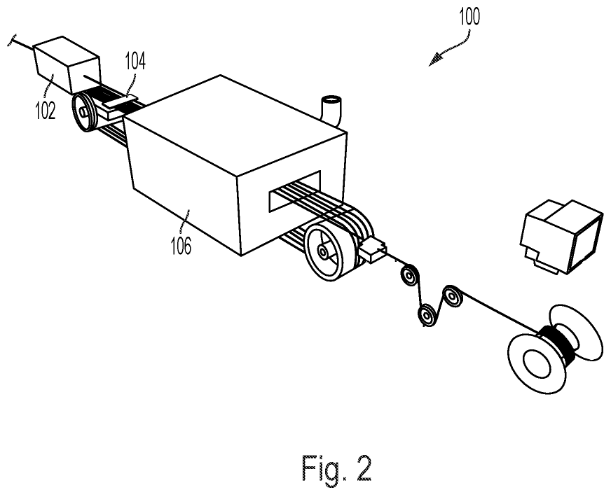

The filler particles may be any of the materials set forth in Table 2 above, or may be any combination of such materials. In one exemplary embodiment, the filler particles are polytetrafluoroethylene (PTFE), fluorinated ethylene-propylene (FEP), or a combination of these. Additional candidate materials for the filler particles include perfluoroalkoxy polymer (PFA) and polyethylene tetrafluoroethylene (ETFE), or combinations thereof. Combinations of any of the foregoing four materials are also contemplated. Generally speaking, exemplary polymer filler particles for insulation layer 14 exhibit a low inherent relative permittivity less than 3.2 and, in a particular exemplary embodiment, 2.2 or less. Where wire 10 is made by conventional magnet wire manufacturing processes, such as using production assembly 100 shown in FIG. 2, insulation 14 may be enhanced with polymers including polyesterimides (PEI) and polyimides (PI), which are known to have relative permittivities of 3.1-3.2.

In one exemplary embodiment, wire 10 is configured for use in connection with electric vehicles or other high-voltage applications. For example, conductor 12 or wire 10 may be a single-strand copper wire having a diameter from 0.51 mm, 1.02 mm or 1.52 mm to 2.03 mm, 2.54 mm or 3.05 mm or within any range using any two of the foregoing as endpoints. However, it is contemplated that conductor 12 may have any size and configuration as may be required or desired for a particular application, including non-round wires having cross-sectional areas corresponding to the areas of the round wire sizes above. For example, where wire 10 is a magnet wire used in connection with electric motors and generators used for electric vehicles, conductor 12 may be a shaped conductor having a non-round cross section (e.g., a generally rectangular cross-section with rounded corners). Wire 10 may be designed according to a desired resistivity and ability to carry current, which may be a function of cross-sectional area, conductor material and purity, and other design factors.

One exemplary non-round wire is shown in FIG. 1C as rectangular wire 110. Wire 110 is similar to wire 10 and reference number used in connection with wire 110 denote the same or analogous structures as the reference numbers used in wire 10, except with 100 added thereto.

However, as illustrated in FIG. 1C, conductor 112 defines a generally rectangular shape as viewed in cross-section, having a width W and a height H, where height H is less than width W. The corners of this rectangular cross-sectional shape may be rounded, as shown. Insulation layer 114 forms a coating of substantially uniform thickness T around the circumference of conductor 112 along its length, and may have all the same materials properties, physical dimensions, and performance characteristics of insulation layer 14 described in detail herein.

In an exemplary embodiment of wire 110, such as for use in stators for electric vehicle (EV) motors, a cross sectional area for conductor 112 is equal to or less than 10 mm² and can be up to 20 mm². The aspect ratio, or width W divided by height H, of this embodiment of wire 110 may be less than 5:1 and can be as high as 10:1. The corners of this embodiment of wire 110 are formed to have a radius maximizing the copper fill in a stator slot. In one embodiment, the corner radius is equal to or less than 0.30 mm and, in any case, is less than one half the height H of the conductor 112.

Rectangular wire 110, may be useful, for example, in electric vehicle (EV) motors for increased efficiency, performance and durability. Rectangular wire 110, as compared to round wires, increases the “fill” volume of a stator slot, which may define a generally trapezoidal void. For bundles of wires with round cross sections, a typical fill volume is 40%. In contrast, fill factors for rectangular wire, such as wire 110, exceed 60%. These higher stator fill factors increase the motor power density, i.e., amount of power per unit volume, and offer higher efficiency. Additionally, the rectangular wire design has approximately 30% less resistance at low speeds than conventional round wire. As a result, a motor incorporating wire 110 has high heat dissipation abilities and cooling that translates into overall higher durability and reliability. For the EV consumer these advantages translate into greater affordability, greater vehicle range (miles per charge), increased acceleration capability, and/or increased powertrain durability.

Achievement of high fill factors as described above elevates dimensional requirements for the rectangular wire 110 when used in a motor, both for the conductor 112 and the insulation layer 114. Such dimensional requirements are substantially more precise and demanding than typical for industrial motors. Advantageously, die forming of the conductor 112 as described herein facilitates the economical maintenance of high dimensional precision for conductor 112. Precision enameling dies and high die pass counts, as described herein, also form insulation layer 114 with similarly high dimensional precision for layer 114. When used in conjunction with one another, wire 110 can meet or exceed the demanding dimensional requirements for precision applications, such as EVs, without undue cost or complexity.

Turning again to FIGS. 1A and 1, insulation 14 may have a thickness T designed to correspond to a desired dielectric breakdown rating (expressed as a voltage), which in turn is a function of the size of conductor 12. The same thickness T is used with wire 110, as described above, and all the following discussion regarding insulation 14 and wires 10 applies equally to wire 110.

For the exemplary conductors 12 described above, for example, insulation 14 may have a thickness T that increases the overall diameter D (or, in the case of wire 110, the overall width W and height H) by approximately 25.4 μm, 50.8 μm or 76.2 μm to 101.6 μm, 127.0 μm, 152.4 μm or 177.8 μm, or within any range using any two of the foregoing as endpoints. Additional specifications for thickness T, given diameter D and the overall construct of wire 10, are described in ANSI/NEMA MW1000-2018, the entire disclosure of which is incorporated herein by reference.

In an 18 gauge (1.02 mm conductor diameter) test configuration of wire 10 with insulation 14 having at least 20 wt. % fluoropolymer filler particles, as described further herein, wire 10 can be expected to have a partial discharge inception voltage (PDIV) of at least 1200 volts as determined in accordance with CEI/IEC 60270:2000, but for particular configurations and builds of wire 10 as described herein, PDIV ratings for wire 10 as configured with may range from 1,200 V, 1,400 V or 1,550 V to 1,600 V, 1,800 V or 2,000 V or within any range using any two of the foregoing as endpoints. In addition to the PDIV ratings demonstrated in the Examples below, further increasing the thickness T of insulation 14 the range of PDIV achievable can be expected to further increase to at least 1,800V or 2,000V.

Wire 10 may therefore exhibit additional performance characteristics associated with its high PDIV. For example, wire 10 may be resistant to dielectric breakdown and allow for long intervals of high-voltage endurance. As demonstrated in the Examples below, an 18-AWG (1.02 mm conductor diameter) test configuration of wire 10 configured according to the present disclosure may exhibit a dielectric breakdown from 13,000 V, 13,500 V or 14,000 V to 15,000 V, 15,500 V or 16,000 V or within any range using any two of the foregoing as endpoints for NEMA “heavy build” (having insulation 14 with a thickness T sufficient to increase wire diameter D by approximately 66 μm-97 μm), and from 16,000 V, 17,000 V or 18,000 V to 20,000 V, 21,000 V or 22,000 V or within any range using any two of the foregoing as endpoints for NEMA “quad build” (having insulation 14 with a thickness T sufficient to increase wire diameter D by approximately 132 μm-166 μm), as measured at room temperature in accordance with ANSI/NEMA MW1000-2018 Sections 3.8.3. For purposes of the present disclosure, “room temperature” is defined as between 20-25 degrees Celsius.

At elevated temperatures of the sort encountered in some high-voltage applications, such as 240° C., configured according to the present disclosure may exhibit a dielectric breakdown from 11,000 V, 11,500 V or 12,000 V to 13,000 V, 14,000 V or 15,000 V or within any range using any two of the foregoing as endpoints for NEMA “heavy build” and from 14,000 V, 15,000 V or 16,000 V to 18,000 V, 19,000 V or 20,000 V or within any range using any two of the foregoing as endpoints for NEMA “quad build”, as defined above and in accordance with ANSI/NEMA MW1000-2018 Sections 3.8.3. Therefore, wire 10 may be expected to survive the high voltages sometimes experienced in high-voltage and dynamic applications, such as electric vehicles, without breakdown or degradation of insulation 14, even when subjected to high ambient and operating temperatures.

Wire 10 is also capable of improved high-voltage endurance. For purposes of the present disclosure, high voltage endurance is measured in accordance with ASTM D2275, except that the test is modified to be performed in liquid water at 80° C. with a test voltage of 1.1 kV. The entirety of ASTM D2275 is incorporated herein by reference. Wire 10 is capable of high-voltage endurance of at least 1,400 minutes to failure, at least 1800 minutes to failure, or at least 2,000 minutes to failure. In an exemplary embodiment, wire 10 is capable of high-voltage endurance of up to 2,500 minutes to failure.

Turning to FIG. 2, one exemplary production assembly 100 is shown in detail. Conductor 12 passes through an annealing oven 102, which thermally processes conductor 12 at a time and temperature appropriate for desired mechanical properties such as ductility and strength. The annealed conductor 12 emerges from oven 102 and passes through coating (or enamel) applicator 104, which applies insulation 14 to conductor 12. Conductor 12 and its newly applied coating of insulation 14 then pass through curing oven 106, which applies heat to at least partially cure, harden and fix insulation 14 upon conductor 12. Some curing may also take place in ambient air. Additional coating and curing steps may be performed iteratively, either to form a multi-layer insulation 14 (as noted above) or to increase the thickness T of the single-layer insulation 14. After all coating and curing is completed, wire 10 is formed.

In an exemplary embodiment, the enamel provided to applicator 104 may be a homogenous mixture. The organic filler particles may be evenly incorporated in the polymer matrix by a mixing device, such as by continuous stirring or other mixing techniques to a create a homogenized mixture, which may be further filtered to remove any non-distributed collections or “clumps” of filler particles from the mixture, further enhancing homogeneity.

This homogenized enamel is then applied to the conductor 12 via applicator 104, and the coated wire is then passed through a series of dies to ensure uniform application of the enamel. As shown in FIG. 2, the conductor 12 is passed through applicator and curing oven several times via several wraps around the respective pulleys of production assembly 100. With each pass, a portion of the enamel for insulation 14 may be applied. This successive application of enamel and passage through progressively larger dies ultimately results in a desired thickness T (FIGS. 1A and 1i). The specific arrangement of components in assembly 100 may be modified as required or desired for a particular application. For example, although curing oven 106 is shown in a horizontal orientation in FIG. 2, a vertically oriented oven may also be used.

In addition to stirring, mixing device 122 may incorporate and disperse the filler particles of insulation 14 in the polymer matrix with a suitable organic solvent or solvent system, helping to create a homogeneous mixture for even and consistent performance along the entire length and about the entire periphery of conductor 12. The preferred filler material may be blended into the polymer matrix using a variety of dispersive techniques. In one exemplary embodiment, the filler may be milled directly into the polymer matrix in the presence of a suitable organic solvent. In other exemplary embodiments, the filler may first be suspended in a suitable solvent and then mechanically blended with the polymer matrix to create a homogenous filled polymer mixture. The filler material may also be dispersed directly into a solution of the polymer matrix, and then blended. In one particular exemplary embodiment, the filler particles and polymer matrix are thoroughly mixed using high-speed dispersion. The resulting insulation 14 may have a substantially homogeneous character with even distribution of the filler particles throughout its entire volume.

In addition to mixing techniques described above, filtration may be used to enhance or preserve the homogeneity of the polymer matrix and filler particles during production of wire 10. For example, one or more in-line filters 124 may be used to remove particles or collections of particles as the solution is mixed and applied. In one exemplary embodiment, filter 124 may be configured to remove particles 10-25 microns in size, or larger. Such in-line filtration prevents undispersed filler particle materials from compromising the overall homogeneity and quality of insulation 14 in the finished wire 10, such that the enamel and resulting insulation 14 is substantially homogeneous.

Unlike predicate magnet wires, wire 10 as described herein uses a relatively large weight-percentage of filler particles in insulation 14. In addition, insulation 14 is produced without the requirement of a fluorinated surfactant. Although some incidental fluorinated surfactants may be found in insulation 14 of wire 10, insulation 14 is substantially free of such fluorinated surfactants in that it contains a total fluorinated surfactant content of less than 0.1 wt. %, less than 0.01 wt. %, or less than 0.001 wt. % based on the total weight of insulation 14, either in the “wet” state prior to application of insulation 14 to the wire or in a “dry” state after application of insulation 14 to the wire followed by curing. Moreover, wire 10 generally excludes surfactants including but not limited to fluorinated surfactants, with all surfactants below the weight percentages discussed above and, in some embodiments, below limits of detectability.

The extensive use of perfluoropolymer particles in the polymer matrix of insulation layer 14 reduces the effective permittivity of insulation 14, thereby allowing high PDIV to be achieved with low thicknesses T in accordance with typical NEMA insulation standards. In addition, wire 10 may be free of traditional corona-protective inorganic fillers, to avoid associated processing difficulties and preserve efficient and cost-effective mass production of wire 10.

Moreover, the composition of insulation 14 in wire 10 allows PDIV to be maintained without increasing thickness T to undesirable levels. As suggested by the PDIV equation noted above, PDIV may be increased by simply increasing the thickness of the insulating layer of a magnet wire. While this may be a feasible method for increases in PDIV, substantial insulation thickness increases are often necessary to achieve desire PDIV levels for certain applications, such as electric vehicles. Such increases in insulation thickness also increase the size, weight, and cost of the electrical equipment in undesirable ways.

By contrast, wire 10 provides an increase in PDIV by decreasing the relative permittivity of the insulation 14, rather than increasing thickness T. This allows wire 10 to be compatible with size constraints inherent to many high-voltage applications in question, while also providing maximum performance advantages for electrical components of a given size and configuration.

### EXAMPLES

### Materials and Methods

In the present Example, three control magnet wire samples were produced. Each sample was prepared using conventional, enamel-based, multi-pass magnet wire manufacturing processes to create first, second and third control samples.

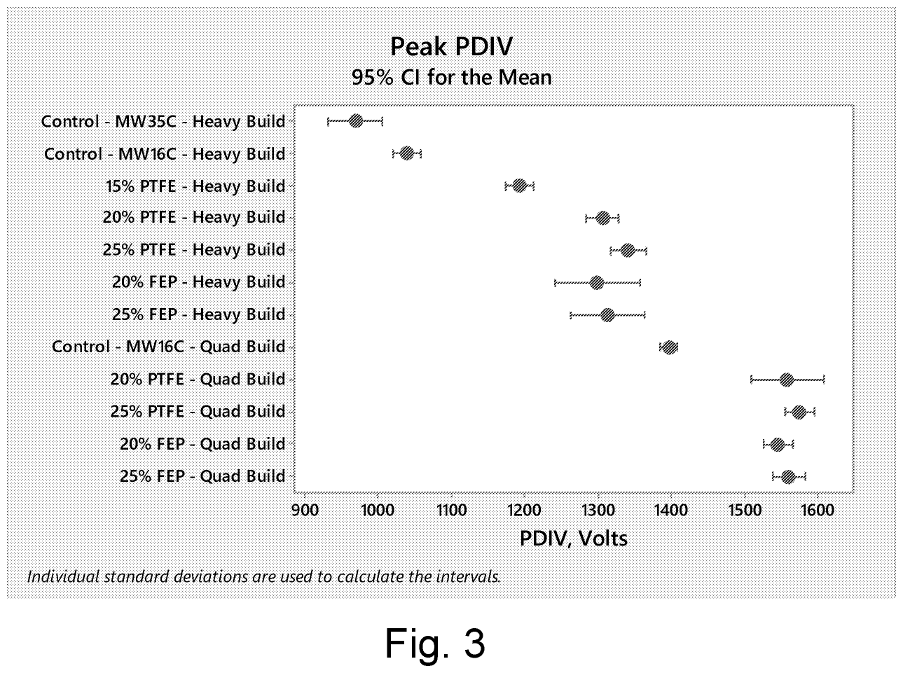

For the first control sample, an 18 AWG (1.02 mm conductor diameter) conventional round copper magnet wire was produced to meet the basic requirements of ANSI/NEMA MW1000 MW 16C, the entirety of which is incorporated herein by reference. This wire was coated with a heavy sole-coat of commercially available polyimide enamel having no filler particles. The insulation coating increased the overall diameter of the wire by approximately 76 μm. This control sample is identified in FIGS. 3-6 as “Control—MW 16C—heavy build”.

For the first control sample, an 18 AWG (1.02 mm conductor diameter) conventional round copper magnet wire was produced to meet the basic requirements of ANSI/NEMA MW1000 MW 35C, the entirety of which is incorporated herein by reference. This wire was coated with a heavy-build insulation comprised of a basecoat, mid-coat and top-coat. The mid-coat layer was comprised of a polyesterimide polymer that is filled with a metal oxide designed to provide resistance to corona discharge. The basecoat and top-coat layers were coated with commercially available polyester and polyamide imide enamels respectively, each having no filler particles. The resulting insulation coating increased the overall diameter of the wire by approximately 76 μm. This control sample is identified in FIGS. 3-6 as “Control—MW 35C—heavy build”.

For the third control sample, an 18 AWG (1.02 mm conductor diameter) conventional round copper magnet wire was produced to meet the basic requirements of ANSI/NEMA MW1000 MW 16C, the entirety of which is incorporated herein by reference. This wire was coated with a quad-build sole-coat of commercially available polyimide enamel having no filler particles. The insulation coating of this material increased the overall diameter of the wire by approximately 152 μm. This control sample is identified in FIGS. 3-6 as “Control—MW 16C—quad build”.

Samples of wire 10, made in accordance with the present disclosure, used an 18 AWG (1.02 mm conductor diameter) round copper magnet wire as conductor 12, produced to meet the requirements of ANSI/NEMA MW1000 MW16C, incorporated above. Insulation 14 was a single-layer coat (as shown in FIG. 1A) of a commercially available polyimide enamel, modified to contain a 20 wt. % by weight dispersion of commercially available finely divided polytetrafluoroethylene (PTFE) filler having an average particle size of 4 μm. The modified polyimide enamel was applied to the conductor using a conventional multiple-pass coating process, as described above with reference to FIG. 2, with a line speed of 12 m/min and a curing oven temperature of 427° C.

A first sample of wire 10 was prepared using the procedure described above, in which the insulation 14 was deposited on conductor 12 using a total of 19 passes through applicator 104 (FIG. 2). The insulation coating 14 of this wire 10 increased the overall diameter of the bare conductor 12 by approximately 76 μm. This sample is identified in FIGS. 3-6 as “20% PTFE—heavy build”.

A second sample of wire 10 was prepared using the procedure described above, in which the insulation 14 was deposited on conductor 12 using a total of 26 passes. The insulation coating 14 of this wire increased the overall diameter of the bare conductor 12 by approximately 152 μm. This sample is identified in FIGS. 3-6 as “20% PTFE—quad build”.

Third and fourth sample of wire 10 was prepared in the same manner as described above for the first and second samples of wire 10, except the enamel used to create insulation 14 contained a 25 wt. % by weight dispersion of polytetrafluoroethylene (PTFE) having an average particle size of 4 μm.

The third sample of wire 10 was prepared using a total of 19 passes, by the same procedure as the first sample of wire 10 described above. Thus, the insulation coating 14 of this wire 10 increased the overall diameter of the wire by approximately 76 μm. This sample is identified in FIGS. 3-6 as “25% PTFE—heavy build”.

The fourth sample of wire 10 was prepared using a total of 26 passes, by the same procedure as the second sample of wire 10 described above. Thus, the insulation coating 14 of this wire 10 increased the overall diameter of the wire by approximately 152 μm. This sample is identified in FIGS. 3-6 as “25% PTFE—quad build”.

Fifth and sixth samples of wire 10 were prepared as described above except the enamel contained a 20 wt. % by weight dispersion of a commercially available fluorinated ethylene-propylene copolymer (FEP) filler particles having an average particle size of 5 μm.

The fifth sample of wire 10 was prepared using a total of 19 passes, by the same procedure as the first sample of wire 10 described above. Thus, the insulation coating 14 of this wire 10 increased the overall diameter of the wire by approximately 76 μm. This sample is identified in FIGS. 3-6 as “20% FEP—heavy build”.

The sixth sample of wire 10 was prepared using a total of 26 passes, by the same procedure as the second sample of wire 10 described above. Thus, the insulation coating 14 of this wire 10 increased the overall diameter of the wire by approximately 152 μm. This sample is identified in FIGS. 3-6 as “20% FEP—quad build”.

Seventh and eighth samples of wire 10 were prepared as described above except the enamel contained a 25 wt. % by weight dispersion of commercially available fluorinated ethylene-propylene copolymer (FEP) filler having an average particle size of 5 μm.

The seventh sample of wire 10 was prepared using a total of 19 passes, by the same procedure as the first sample of wire 10 described above. Thus, the insulation coating 14 of this wire 10 increased the overall diameter of the wire by approximately 76 μm. This sample is identified in FIGS. 3-6 as “25% FEP—heavy build”.

The eighth sample of wire 10 was prepared using a total of 26 passes, by the same procedure as the second sample of wire 10 described above. Thus, the insulation coating 14 of this wire 10 increased the overall diameter of the wire by approximately 152 μm. This sample is identified in FIGS. 3-6 as “25% FEP—quad build”.

A ninth sample of wire 10 was prepared as described above except the enamel contained a 15 wt. % by weight dispersion of polytetrafluoroethylene (PTFE) filler having an average particle size of 4 μm.

The ninth sample of wire 10 was prepared using the procedure described above, in which the insulation 14 was deposited on conductor 12 using a total of 20 passes through applicator 104 (FIG. 2). The insulation coating 14 of this wire 10 increased the overall diameter of the bare conductor 12 by approximately 76 μm. This sample is identified in FIGS. 3-6 as “15% PTFE—heavy build”.

### Example 1—PDIV Study

PDIV was measured as described in CEI/IEC 60270:2000, the entirety of which is incorporated herein by reference, using a Soken Model DAC-PD-7 Partial Discharge Tester. The measurements were performed at room temperature with an ambient humidity of approximately 20%. Test samples evaluated were NEMA twisted pairs, prepared as described in ANSI/NEMA MW1000-2018 3.8.3, the entirety of which is incorporated herein by reference, using 8 twists under 1.36-kg tension.

These test results are shown in FIG. 3. As illustrated, the incorporation of organic fluorocarbon polymers having low relative permittivity into the insulation 14 of wire 10 significantly and unambiguously improved PDIV characteristics compared to the control samples.

For the “heavy-build” samples, the incorporation of 15 wt. % PTFE filler particles into insulation 14 resulted in a ca. 200V increase in peak PDIV when compared to the control samples of similar build. When the proportion of filler particles is increased to 20 wt. % and 25 wt. % PTFE, there was a ca. 300-500V increase in peak PDIV when compared to the control samples. In these examples peak PDIV values of over 1300V were measured for the wires made in accordance with the present disclosure.

Similar trends were observed with the “quad-build” samples. Samples with 20 wt. % and 25 wt. % PTFE filler particles in insulation 14 of wires 10 exhibited measured peak PDIV values that were approximately 150-200V higher than the corresponding “quad-build” control sample. In these examples peak PDIV values in excess of 1550V were measured for the wires made in accordance with the present disclosure.

Notably, the use of a different perfluoropolymer filler particles—namely FEP—yielded PDIV results that were very similar to those obtained by using PTFE. This comports with the design principles of wire 10 as described above, in which permittivity of filler particles is associated with PDIV; PTFE and FEP share the same (very low) relative permittivity of about 2.1.

As expected from the PDIV equation presented above, the “quad-build” PTFE and FEP samples showed significantly higher PDIV values than the corresponding “heavy” build samples. With the increased thickness T of the insulation 14 for wires 10 labeled “quad build,” peak PDIV values of up to 1,600V were achieved.

### Example 2—Dielectric Breakdown Study

Dielectric breakdown was measured at room temperature and at 240 C as described in ANSI/NEMA MW1000-2018 Sections 3.8.3 and 3.52 respectively, both of which are incorporated herein by reference. Dielectric breakdown was measured using an Ampac Nova 1401-LCT-30 kV Dielectric Breakdown tester. Test samples evaluated were NEMA twisted pairs, prepared using 8 twists under 1.36-kg tension.

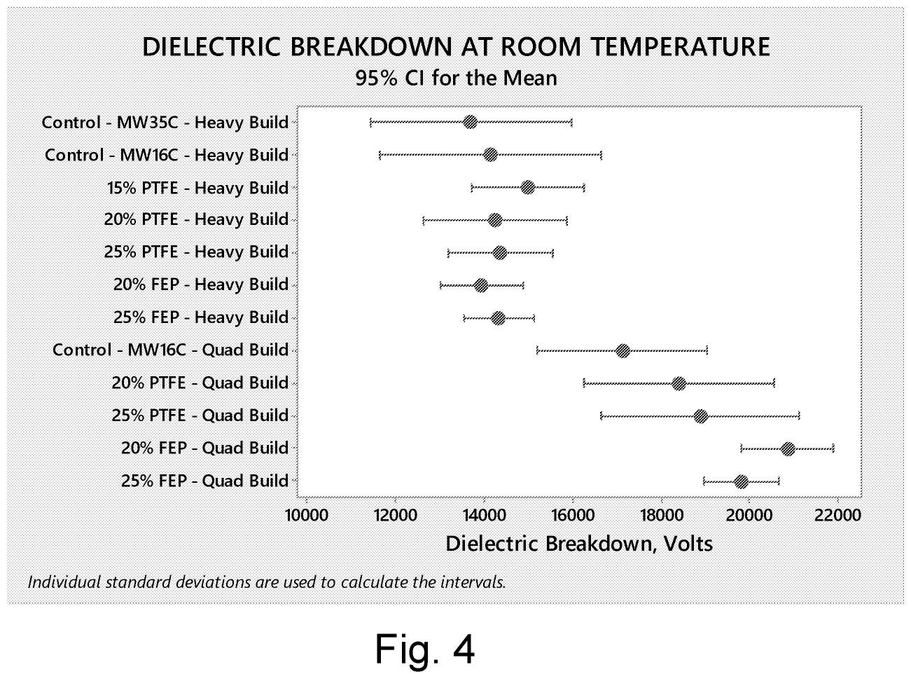

As shown in FIG. 4, the results indicated that the “heavy-build” samples of wire 10 containing 15 wt. %, 20 wt. % and 25 wt. % PTFE filler particles, and 20 wt. % and 25 wt. % FEP filler particles, all had room temperature dielectric breakdown voltages that were comparable to the two “heavy-build” control samples.

The corresponding fluoropolymer-filled “quad-build” samples of wire 10 showed a modest increase in dielectric breakdown voltage compared to the “quad-build” control sample.

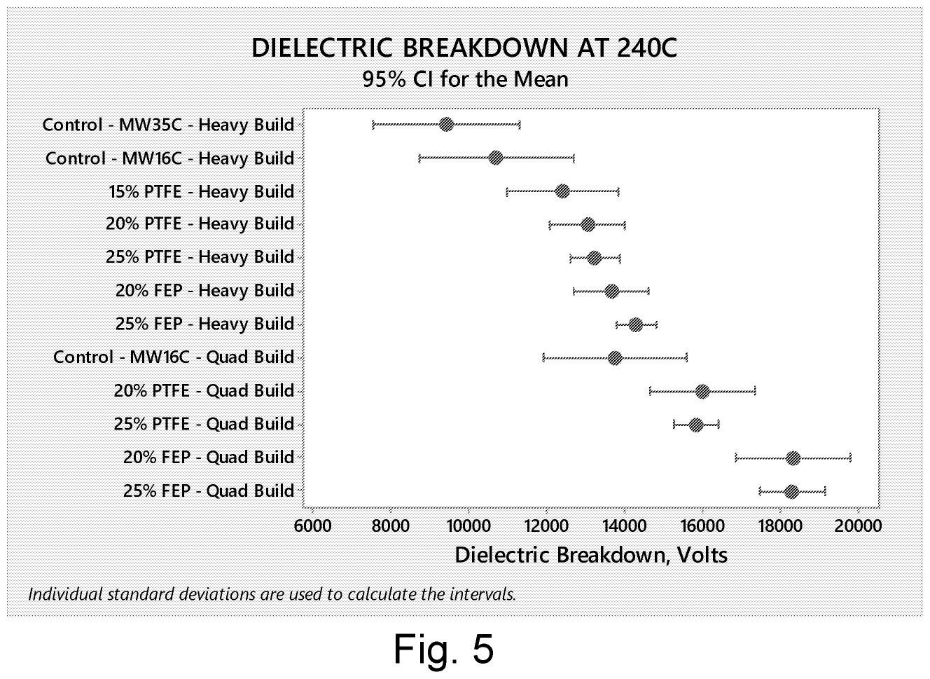

Turning to FIG. 5, however, the test results at 240° C. clearly illustrate the superiority of wires 10 incorporating organic fluorocarbon polymer particles into their respective insulations 14. The data of FIG. 5 demonstrate that wires 10 provide a significant high-temperature dielectric breakdown improvement compared to the control samples.

### Example 3—High Voltage Endurance Study

High voltage endurance was measured as described in ASTM D2275, the entirety of which is incorporated by reference, except that the test was modified to be performed with twisted bifilar pairs in moisture (e.g., liquid water) at a temperature of 80° C. An Ampac Model MP-1000 High Voltage Endurance Tester was used with a test voltage of 1.1 kV. Ten samples were tested simultaneously and the average time to failure was recorded.

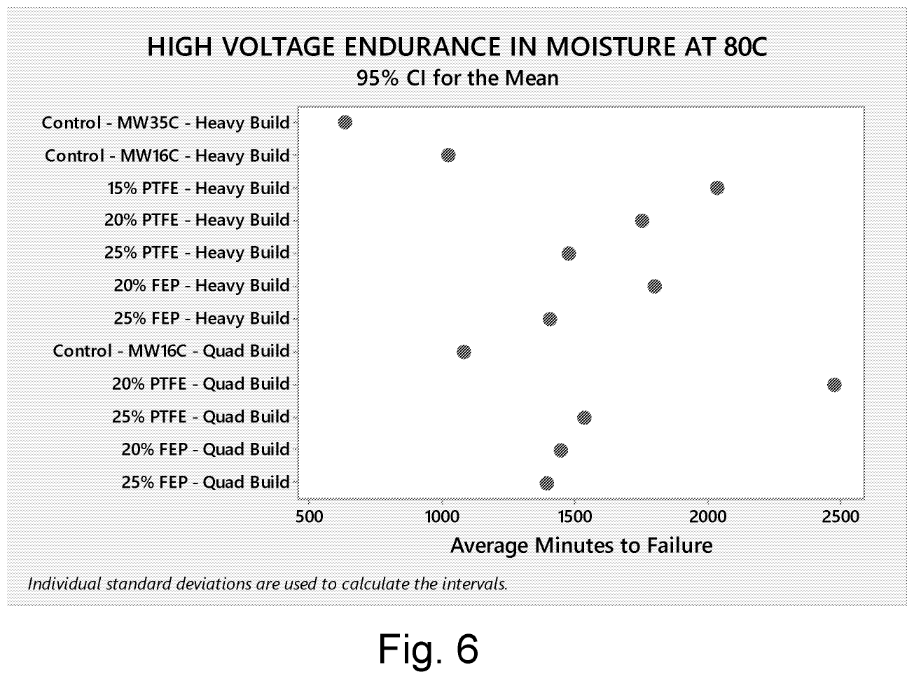

As shown in FIG. 6, the results illustrate that high voltage endurance was improved in the samples of wire 10 including fluoropolymer filler particles dispersed in the insulation layers 14 as described above. In addition, the results suggest that PTFE particles could be a better inhibitor of corona discharge than the metal oxide used in the MW 35 C control sample.

As described herein and demonstrated by the Examples, the use of fluoropolymer filler particles having low relative permittivity and high dielectric strength dispersed in the wire insulation has been proven to significantly increase the PDIV performance of magnet wire. In certain exemplary embodiments described above, it is possible to achieve peak PDIV values in excess of 1500V without increasing insulation thickness beyond NEMA build specifications. By further increasing the thickness T of insulation 14 the range of PDIV achievable can be expected to further increase to at least 1,800V or 2,000V.

Additionally, the wires manufactured with a fluoropolymer filler particles as described herein significantly improves the dielectric breakdown voltage at high temperature, and in high voltage endurance when the test is performed with bifilar twisted pairs in moisture environments.

### Example 4—Rectangular Wire

Shaped, non-round wires is provided having a shape generally shown in FIG. 1C, and coated with insulation as generally shown and described herein. Various non-round wires are made with each of the various types of insulation described herein.

A series of tests are performed in accordance with Examples 1 and 2 above. For example, PDIV was measured as described in CEI/IEC 60270:2000, the entirety of which is incorporated herein by reference, using a Soken Model DAC-PD-7 Partial Discharge Tester. The measurements were performed at room temperature with an ambient humidity of approximately 20%. Test samples evaluated were lashed pairs, where the width sections are opposing each other with zero gap. Similar results are obtained for rectangular wires as for the round-wire samples discussed herein.

As another example, dielectric breakdown was measured at room temperature and at 240 C as described in ANSI/NEMA MW1000-2018 Sections 3.8.7 and 3.52 respectively, both of which are incorporated herein by reference. Dielectric breakdown was measured using an Ampac Nova 1401-LCT-30 kV Dielectric Breakdown tester. Similar results are obtained for rectangular wires, with similar insulation thickness, as for the round-wire samples discussed herein.

As described herein and demonstrated by the Examples, the use of fluoropolymer filler particles having low relative permittivity and high dielectric strength dispersed in the wire insulation has been proven to significantly increase the performance of a shaped, e.g., rectangular magnet wire.

### Aspects

Aspect 1 is a magnet wire, including a conductor wire and an insulation layer on the conductor wire. The insulation layer includes a polymer matrix and filler particles dispersed within the polymer matrix, the filler particles comprising a fluoropolymer and present in an amount of at least 20 wt. % based on a total weight of the insulation layer. An 18-AWG (1.02 mm conductor diameter) magnet wire 10 having an insulation layer 14 which increases the wire diameter by approximately 76 μm has a PDIV of at least 1,200 volts as determined in accordance with CEI/IEC 60270:2000.

Aspect 2 is the magnet wire of Aspect 1, wherein the fluoropolymer of the filler particles is selected from polytetrafluoroethylene (PTFE), fluorinated ethylene-propylene (FEP), and a combination of the foregoing.

Aspect 3 is the magnet wire of Aspect 1 or Aspect 2, wherein the polymer matrix comprises a polyimide polymer having a relative permittivity of 3.2 or less.

Aspect 4 is the magnet wire of any of Aspects 1-3, wherein the filler particles are present in an amount from 20 wt. % to 30 wt. %, based on a total weight of the insulation layer.

Aspect 5 is the magnet wire of any of Aspects 1-4, having a dielectric breakdown voltage of at least 13,000 volts, measured at room temperature in accordance with ANSI/NEMA MW1000-2018 Section 3.8.3.

Aspect 6 is the magnet wire of any of Aspects 1-5, having a dielectric breakdown voltage of at least 11,000 volts, measured at 240° C. in accordance with ANSI/NEMA MW1000-2018 Section 3.8.3.

Aspect 7 is the magnet wire of any of Aspects 1-6, having a high voltage endurance of at least 1,400 minutes to failure, in accordance with ASTM D2275, except that the test was modified to be performed in liquid water at 80° C. with a test voltage of 1.1 kV.

Aspect 8 is the magnet wire of any of Aspects 1-7, having a high voltage endurance between 1,400 minutes and 2,500 minutes to failure, in accordance with ASTM D2275, except that the test was modified to be performed in liquid water at 80° C. with a test voltage of 1.1 kV.

Aspect 9 is the magnet wire of any of Aspects 1-8, having at least one of a partial discharge inception voltage from 1,200 volts to 2,000 volts, as determined in accordance with CEI/IEC 60270:2000, a dielectric breakdown voltage from 13,000 volts to 22,000 volts, measured at room temperature in accordance with ANSI/NEMA MW1000-2018 Sections 3.8.3, and a dielectric breakdown voltage from 11,000 volts to 20,000 volts, measured at 240° C. in accordance with ANSI/NEMA MW1000-2018 Sections 3.8.3.

Aspect 10 is the magnet wire of any of Aspects 1-9, wherein the insulation layer includes less than 5 wt. % total inorganic fillers, based on a total weight of the insulation layer.

Aspect 11 is the magnet wire of any of Aspects 1-10, wherein the insulation layer is a single layer, wherein the insulation layer is in direct contact with the conductor wire and having an exposed exterior surface.

Aspect 12 is the magnet wire of any of Aspects 1-11, further including a basecoat in direct contact with the conductor wire, the insulation layer covering the basecoat, and a topcoat covering the insulation layer, the topcoat having an exposed exterior surface.

Aspect 13 is the magnet wire of any of Aspects 1-12, wherein the conductor wire is a single strand.

Aspect 14 is the magnet wire of any of Aspects 1-13, wherein the insulation layer includes a total of less than 0.1 wt. % fluorinated surfactants, based on a total weight of the insulation layer.

Aspect 15 is the magnet wire of any of Aspect 1-14, wherein the filler particles have an average particle size between 0.1 μm and 100 μm.

Aspect 16 is the magnet wire of any of Aspects 1-15, wherein the conductor wire is a round wire defining a diameter in cross-section.

Aspect 17 is the magnet wire of any of Aspects 1-15, wherein the conductor wire is a non-round wire in cross-section.

Aspect 18 is the magnet wire of Aspect 17, wherein the conductor wire is a rectangular wire defining a width and a height less than the width in cross-section.

Aspect 19 is the magnet wire of Aspect 18, wherein the rectangular wire has rounded edges each defining a radius not greater than one half of the height.

Aspect 20 is the magnet wire of Aspects 18 or 19, wherein the rectangular wire defines a cross-section area up to 20 mm².

Aspect 21 is the magnet wire of any of Aspects 18-20, wherein the rectangular wire defines an aspect ratio of the width divided by the height, of up to 10:1.

Aspect 22 is a magnet wire, including a conductor wire having a rectangular cross-section defining a width and a height less than the width, and an insulation layer on the conductor wire. The insulation layer includes a polymer matrix, and filler particles dispersed within the polymer matrix. The filler particles include a fluoropolymer and present in an amount of at least 20 wt. % based on a total weight of the insulation layer.

Aspect 23 is a method of manufacturing magnet wire, including coating an insulation layer onto a conductor wire, and curing, at least partially, the insulation layer. The insulation layer includes a liquid polymer matrix, the polymer matrix comprising a polyimide polymer having a relative permittivity of 3.2 or less, and fluoropolymer filler particles dispersed within the liquid polymer matrix, the filler particles present in an amount from 20 wt. % to 30 wt. %, based on a total weight of the insulation layer.

Aspect 24 is the method of Aspect 23, wherein the coating and curing steps are performed repeatedly to build a thickness of the insulation layer to a finished thickness.

Aspect 25 is the method of Aspect 23 or Aspect 24, further comprising the additional step of filtering the liquid polymer matrix using at least one filter having openings from 10 to 25 microns.

Aspect 26 is the method of any of Aspects 23-25, wherein the fluoropolymer of the filler particles is selected from polytetrafluoroethylene (PTFE), fluorinated ethylene-propylene (FEP), and a combination of the foregoing.

Aspect 27 is the method of any of Aspects 23-26, wherein the insulation layer includes a total of less than 0.1 wt. % fluorinated surfactants, based on a total weight of the insulation layer.

Various modifications and additions may be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

1. A magnet wire, comprising:
a conductor wire; and
an insulation layer on the conductor wire comprising:
a polymer matrix; and
filler particles dispersed within the polymer matrix, the filler particles comprising a fluoropolymer and present in an amount of at least 20 wt. % based on a total weight of the insulation layer; and
the magnet wire having a partial discharge inception voltage of at least 1,200 volts as determined in accordance with CEI/IEC 60270:2000.

2. The magnet wire of claim 1, wherein the fluoropolymer of the filler particles is selected from polytetrafluoroethylene (PTFE), fluorinated ethylene-propylene (FEP), and a combination of the foregoing.

3. The magnet wire of claim 1, wherein the polymer matrix comprises a polyimide polymer having a relative permittivity of 3.2 or less.

4. The magnet wire of claim 1, wherein the filler particles are present in an amount from 20 wt. % to 30 wt. %, based on a total weight of the insulation layer.

5. The magnet wire of claim 1, having a dielectric breakdown voltage of at least 13,000 volts, measured at room temperature in accordance with ANSI/NEMA MW1000-2018 Section 3.8.3.

6. The magnet wire of claim 1, having a dielectric breakdown voltage of at least 11,000 volts, measured at 240° C. in accordance with ANSI/NEMA MW1000-2018 Section 3.8.3.

7. The magnet wire of claim 1, having a high voltage endurance of at least 1,400 minutes to failure, measured at 80° C. in accordance with ASTM D2275, the test modified to be performed in liquid water at 80° C. with a test voltage of 1.1 kV.

8. The magnet wire of claim 1, having a high voltage endurance between 1,400 minutes and 2,500 minutes to failure, measured at 80° C. in accordance with ASTM D2275.

9. The magnet wire of claim 1, having at least one of:
a partial discharge inception voltage from 1,200 volts to 2,000 volts, as determined in accordance with CEI/IEC 60270:2000;
a dielectric breakdown voltage from 13,000 volts to 22,000 volts, measured at room temperature in accordance with ANSI/NEMA MW1000-2018 Sections 3.8.3; and
a dielectric breakdown voltage from 11,000 volts to 20,000 volts, measured at 240° C. in accordance with ANSI/NEMA MW1000-2018 Sections 3.8.3.

10. The magnet wire of claim 1, wherein the insulation layer includes less than 5 wt. % total inorganic fillers, based on a total weight of the insulation layer.

11. The magnet wire of claim 1, wherein the insulation layer is a single layer, wherein the insulation layer is in direct contact with the conductor wire and having an exposed exterior surface.

12. The magnet wire of claim 1, further comprising:
a basecoat in direct contact with the conductor wire;
the insulation layer covering the basecoat; and
a topcoat covering the insulation layer, the topcoat having an exposed exterior surface.

13. The magnet wire of claim 1, wherein the conductor wire is a single strand.

14. The magnet wire of claim 1, wherein the insulation layer includes a total of less than 0.1 wt. % fluorinated surfactants, based on a total weight of the insulation layer.

15. The magnet wire of claim 1, wherein the filler particles have an average particle size between 0.1 μm and 100 μm.

16. The magnet wire of claim 1, wherein the conductor wire is a round wire defining a diameter in cross-section.

17. The magnet wire of claim 1, wherein the conductor wire is a non-round wire in cross-section.

18. The magnet wire of claim 17, wherein the conductor wire is a rectangular wire defining a width and a height less than the width in cross-section.

19. The magnet wire of claim 18, wherein the rectangular wire has rounded edges each defining a radius not greater than one half of the height.

20. The magnet wire of claim 18, wherein the rectangular wire defines a cross-section area up to 20 mm².

21. The magnet wire of claim 18, wherein the rectangular wire defines an aspect ratio of the width divided by the height, of up to 10:1.

22. A magnet wire, comprising:
a conductor wire having a rectangular cross-section defining a width and a height less than the width; and
an insulation layer on the conductor wire comprising:
a polymer matrix; and
filler particles dispersed within the polymer matrix, the filler particles comprising a fluoropolymer and present in an amount of at least 20 wt. % based on a total weight of the insulation layer.

23. A method of manufacturing magnet wire, comprising:
coating an insulation layer onto a conductor wire, the insulation layer comprising:
a liquid polymer matrix, the polymer matrix comprising a polyimide polymer having a relative permittivity of 3.2 or less; and
fluoropolymer filler particles dispersed within the liquid polymer matrix, the filler particles present in an amount from 20 wt. % to 30 wt. %, based on a total weight of the insulation layer; and
curing, at least partially, the insulation layer.

24. The method of claim 23, wherein the coating and curing steps are performed by a multi-pass magnet wire production process to build a thickness of the insulation layer to a finished thickness.

25. The method of claim 23, further comprising the additional step of filtering the liquid polymer matrix using at least one filter having openings from 10 to 25 microns.

26. The method of claim 23, wherein the fluoropolymer of the filler particles is selected from polytetrafluoroethylene (PTFE), fluorinated ethylene-propylene (FEP), and a combination of the foregoing.

27. The method of claim 23, wherein the insulation layer includes a total of less than 0.1 wt. % fluorinated surfactants, based on a total weight of the insulation layer.
